(19) United States
(12) Patent Application Publication
(10) Pub. No.: US 2026/0138101 A1
(43) Pub. Date: May 21, 2026

(54) POSITIVE ELECTRODE MATERIAL PRODUCTION DEVICE AND POSITIVE ELECTRODE MATERIAL PRODUCTION METHOD FOR SOLID-STATE BATTERY

(71) Applicant: HONDA MOTOR CO., LTD., Tokyo (JP)

(72) Inventors: Tomoya OYAMA, Saitama (JP); Taku SAITO, Saitama (JP)

(73) Assignee: HONDA MOTOR CO., LTD., Tokyo (JP)

(21) Appl. No.: 19/392,763

(22) Filed: Nov. 18, 2025

(30) Foreign Application Priority Data
Nov. 18, 2024 (JP) 2024-200737

(51) Int. Cl. B01F 23/50; B01F 23/70; B07B 1/00; H01M 4/04

(52) U.S. Cl. CPC B01F 23/511; B01F 23/565; B01F 23/713; B07B 1/00; H01M 4/04; B01F 2215/0454

(57) ABSTRACT

A positive electrode material production device for a solid-state battery has a classifier that classifies a mixed powder of a powder of a positive electrode active material and a powder of a solid electrolyte into a coarse powder and a fine powder, and a kneader that kneads the fine powder and a dispersion medium to generate a positive electrode slurry. The classifier includes a container into which the mixed powder is fed, and a vibrator that is attached to the container and vibrates at an ultrasonic vibration frequency. A bottom surface of the container has a plurality of openings configured to allow the fine powder to pass through.

### CROSS-REFERENCE TO RELATED APPLICATIONS

This application is based on and claims priority under 35 USC 119 from Japanese Patent Application No. 2024-200737 filed on November 18, 2024, the entire content of which is incorporated herein by reference.

### TECHNICAL FIELD

The present disclosure relates to a positive electrode material production device and a positive electrode material production method for a solid-state battery.

### BACKGROUND ART

In recent years, researches and developments have been conducted on a secondary battery which contributes to improvement in energy efficiency in order to allow more people to have access to affordable, reliable, sustainable and advanced energy.

Among the secondary batteries, a solid-state secondary battery using a solid electrolyte is particularly attracting attention because the solid electrolyte is nonflammable and thus is excellent in terms of improving safety and has a higher energy density. For example, CN116654897A and JP6116315B propose methods for producing electrode materials (positive electrode material and negative electrode material) for solid-state batteries.

JP6116315B discloses a method for producing a small amount of positive electrode material on a laboratory scale. Meanwhile, when considering a large-scale production method for producing a large amount of positive electrode material, it is necessary to consider a technique capable of shortening a production time in order to increase production efficiency.

### SUMMARY OF INVENTION

The present disclosure relates to production of a positive electrode material for a solid-state battery, and provides a positive electrode material production device and a positive electrode material production method for the solid-state battery, which enable to shorten a production time. This further contributes to improvement in energy efficiency.

A first aspect of the present disclosure is to a positive electrode material production device for a solid-state battery, having:

a classifier configured to classify a mixed powder of a powder of a positive electrode active material and a powder of a solid electrolyte into a coarse powder and a fine powder; and

a kneader configured to knead the fine powder and a dispersion medium to generate a positive electrode slurry, in which

the classifier includes:

a container in which the mixed powder is fed into the container, and a plurality of openings configured to allow the fine powder to pass through are formed in a bottom surface of the container; and

a vibrator attached to the container and configured to vibrate at an ultrasonic vibration frequency.

A second aspect of the present disclosure is to a positive electrode material production method for a solid-state battery, including:

classifying a mixed powder of a powder of a positive electrode active material and a powder of a solid electrolyte into a coarse powder and a fine powder; and

kneading the fine powder and a dispersion medium to generate a positive electrode slurry, in which

in the classifying the mixed powder, the mixed powder is classified by vibrating a container with a vibrator configured to vibrate at an ultrasonic vibration frequency, in which a plurality of openings configured to allow the fine powder to pass through are formed in a bottom surface of the container, and the mixed powder is fed into the container.

A particle size of a positive electrode active material (mixed powder) coated with the solid electrolyte increases due to aggregation. However, according to the aspects of the present disclosure, by classifying the mixed powder before kneading for generating a positive electrode slurry, particles having a large size that adversely affect performance of the solid-state battery can be removed early in a production line.

Further, according to the aspects of the present disclosure, a time for the classification can be shortened by classifying the mixed powder by a vibrator that can vibrate at an ultrasonic vibration frequency. As a result, the production time of the positive electrode material can be shortened.

### BRIEF DESCRIPTION OF DRAWINGS

Exemplary embodiment(s) of the present invention will be described in detail based on the following figures, wherein:

FIG. 1 is a cross-sectional view of a solid-state battery 1 according to an embodiment of the present disclosure;

FIG. 2 is a flowchart of a positive electrode material production method according to the embodiment of the present disclosure;

FIG. 3 is a block diagram illustrating a schematic configuration of a positive electrode material production device 100 according to the embodiment of the present disclosure; and

FIG. 4 illustrates a configuration of a classifier 110.

### DESCRIPTION OF EMBODIMENTS

Hereinafter, an embodiment of a positive electrode material production device and a positive electrode material production method for a solid-state battery according to the present disclosure will be described with reference to the accompanying drawings. First, the solid-state battery will be described. In the present specification, the solid-state battery is a battery that is made entirely solid.

### (1. Solid-State Battery)

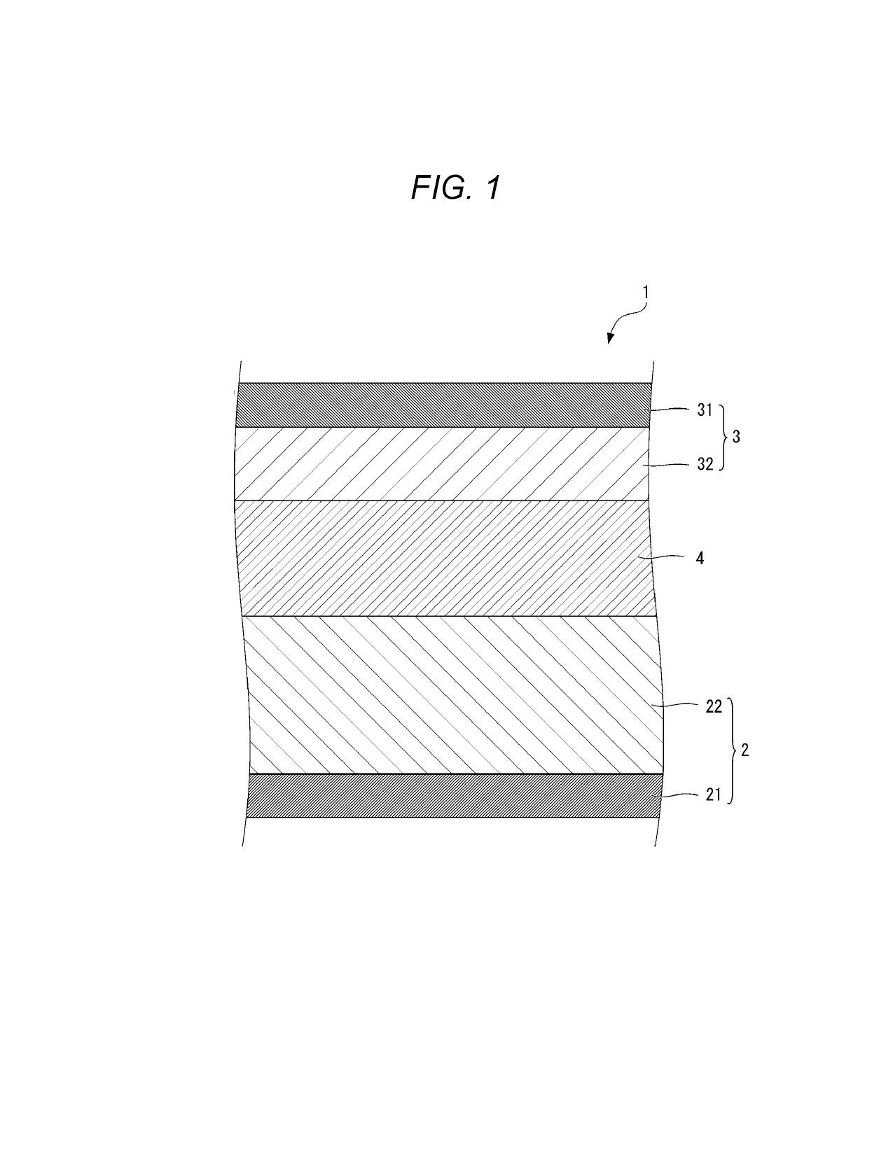

FIG. 1 is a cross-sectional view of a solid-state battery 1. The solid-state battery 1 includes a positive electrode layer 2, a negative electrode layer 3, and a solid electrolyte layer 4 disposed between the positive electrode layer 2 and the negative electrode layer 3. The positive electrode layer 2, the solid electrolyte layer 4, and the negative electrode layer 3 are stacked in this order. The solid-state battery 1 is not particularly limited, and is a lithium ion solid-state secondary battery or a lithium metal secondary battery.

The positive electrode layer 2 includes a positive electrode current collector 21 and a positive electrode active material layer 22 stacked on each other. In the present specification, a sheet-shaped member constituting the positive electrode layer 2 before being stacked on the solid electrolyte layer 4 or the negative electrode layer 3 may be referred to as a positive electrode material.

The positive electrode current collector 21 has a function of collecting current from the positive electrode active material layer 22. The positive electrode current collector 21 preferably includes at least one material having high conductivity. Examples of a highly conductive material include aluminum, an aluminum alloy, stainless steel, nickel, iron, and titanium.

Examples of a shape of the positive electrode current collector 21 include a foil shape, a plate shape, a mesh shape, a nonwoven fabric shape, and a foam shape. A surface of the positive electrode current collector 21 may be roughened in order to enhance adhesion to the positive electrode active material layer 22.

The positive electrode active material layer 22 contains, for example, a positive electrode active material and a solid electrolyte. The positive electrode active material layer 22 is formed by applying a positive electrode slurry, which is generated by kneading the positive electrode active material and the solid electrolyte together with a dispersion medium, to the positive electrode current collector 21, and drying the positive electrode slurry. Here, the dispersion medium includes conductive assistance, a binder, and a solvent.

The positive electrode active material can be similar as that used for a positive electrode material of a general solid-state battery. Examples of the positive electrode active material include lithium-cobalt composite oxide, lithium-nickel composite oxide, lithium-nickel-cobalt composite oxide, lithium-nickel-manganese composite oxide, lithium-nickel-cobalt-manganese composite oxide, and lithium-nickel-cobalt-aluminum composite oxide. Specific examples of the positive electrode active material include LiCoO₂ and LiNiₚMn_{q}CoᵣO₂ (p+q+r=1), LiNiₚAl_{q}CoᵣO₂ (p+q+r=1). The positive electrode active material may be a material containing a metal element such as Cr, Fe, V, Mg, Ca, Na, Ti, Zr, Nb, Mo, W, Cu, Zn, Ga, In, Sn, La, and Ce.

The solid electrolyte contained in the positive electrode active material layer 22 can be similar as that used in a general solid-state battery, and examples thereof include a similar solid electrolyte as a solid electrolyte (described later) contained in the solid electrolyte layer 4. Examples of the solid electrolyte contained in the positive electrode active material layer 22 include a sulfide-based solid electrolyte.

The conductive assistance contained in the dispersion medium can be similar as that used in a general solid-state battery, and examples thereof include carbon black, carbon nanotubes, graphene, and graphite particles.

The binder contained in the dispersion medium can be similar as that used in a general solid-state battery, and examples thereof include polyvinylidene fluoride (PVDF), polymethyl methacrylate (PMMA), polyisobutene (PIB), styrene-butadiene rubber (SBR), polyethylene-vinyl acetate copolymer (PEVA), nitrile rubber (NBR), and hydrogenated nitrile rubber (HNBR).

The solvent contained in the dispersion medium can be similar as that used in a general solid-state battery, and examples thereof include an organic solvent such as N-methyl-2-pyrrolidone (NMP), toluene, butyl butyrate, or alcohol, or water.

The negative electrode layer 3 includes a negative electrode current collector 31 and a negative electrode active material layer 32 stacked on each other. In the present specification, a sheet-shaped member constituting the negative electrode layer 3 before being stacked on the solid electrolyte layer 4 or the positive electrode layer 2 may be referred to as a negative electrode material.

The negative electrode current collector 31 has a function of collecting current from the negative electrode active material layer 32. The negative electrode current collector 31 preferably includes at least one material having high conductivity. Examples of a highly conductive material include copper, nickel, and stainless steel.

Examples of a shape of the negative electrode current collector 31 include a foil shape, a plate shape, a mesh shape, a nonwoven fabric shape, and a foam shape. A surface of the negative electrode current collector 31 may be roughened in order to enhance adhesion to the negative electrode active material layer 32.

The negative electrode active material layer 32 contains, for example, a negative electrode active material and a solid electrolyte. The negative electrode active material layer 32 is formed by applying a negative electrode slurry, which is generated by kneading the negative electrode active material and the solid electrolyte together with a dispersion medium, to the negative electrode current collector 31, and drying the negative electrode slurry. The dispersion medium includes conductive assistance, a binder, and a solvent, and each material can be similar as that used in a general solid-state battery.

The negative electrode active material can be similar as that used for a negative electrode material of a general solid-state battery. Examples of the negative electrode active material include lithium metal, lithium alloys, silicon-based active materials such as Si and Si alloys, lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, and metallic indium.

The solid electrolyte contained in the negative electrode active material layer 32 can be similar as that used in a general solid-state battery, and examples thereof include a similar solid electrolyte as the solid electrolyte (described later) contained in the solid electrolyte layer 4. Examples of the solid electrolyte contained in the negative electrode active material layer 32 include a sulfide-based solid electrolyte.

The solid electrolyte layer 4 is formed between the positive electrode layer 2 and the negative electrode layer 3. The solid electrolyte layer 4 may be formed in a plurality of layers. A material constituting the solid electrolyte layer 4 can be similar as that used for a solid electrolyte of a general solid-state battery, and examples thereof include a sulfide-based solid electrolyte material. The sulfide-based solid electrolyte material usually contains a metal element (M) serving as a conducting ion and sulfur (S). Examples of the M include Li, Na, K, Mg, and Ca, and among them, Li is preferable. In particular, the sulfide-based solid electrolyte material preferably contains Li, A (A is at least one selected from the group consisting of P, Si, Ge, Al, and B), and S, and among them, A is more preferably phosphorus (P). Further, the sulfide-based solid electrolyte material may contain halogen such as Cl, Br, or I. This is because ion conductivity is improved by containing halogen. The sulfide-based solid electrolyte material may contain O.

Examples of the sulfide-based solid electrolyte material having ion conductivity include Li₂S-P₂S₅, Li₂S-P₂S₅-LiI, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (where m and n are positive numbers, and Z is any of Ge, Zn, and Ga), Li₂S-GeS₂, Li₂S-SiS₂-Li₃PO₄, and Li₂S-SiS₂-LiₓMO_{y} (where x and y are positive numbers, and M is any of P, Si, Ge, B, Al, Ga, and In). The description of "Li₂S-P₂S₅" means a sulfide-based solid electrolyte material using a raw material composition containing Li₂S and P₂S₅, and the same applies to other descriptions.

Other examples of the material constituting the solid electrolyte layer 4 include inorganic solid electrolytes such as an oxide solid electrolyte, a halide solid electrolyte, and a lithium-containing salt, and polymer-based solid electrolytes such as polyethylene oxide. As the material constituting the solid electrolyte layer 4, one type may be used, or two or more types may be used in combination.

The solid-state battery 1 may further include an intermediate layer disposed between the negative electrode layer 3 and the solid electrolyte layer 4. For example, when the solid-state battery 1 is a lithium metal secondary battery, the intermediate layer has a function of uniformly depositing a lithium metal. A material constituting the intermediate layer is not particularly limited, and examples thereof include a metal that can be alloyed with lithium and amorphous carbon.

### (2. Positive Electrode Material Production Device and Production Method)

Next, a positive electrode material production device and a positive electrode material production method for producing a positive electrode material used in the solid-state battery 1 described above will be described in detail.

In the positive electrode material production device and the positive electrode material production method according to the present embodiment, as the positive electrode active material, particles of the positive electrode active material coated in advance with particles of the solid electrolyte are used. In the following description, the positive electrode active material coated with the solid electrolyte is also referred to as a coated positive electrode active material. The coated positive electrode active material is a mixed powder generated by mixing a powder of the positive electrode active material and a powder of the solid electrolyte by a dry method without using a dispersion medium. The solid electrolyte used for the coating can be similar as that used in a general solid-state battery, and examples thereof include a sulfide-based solid electrolyte. The solid electrolyte used for the coating may be a solid electrolyte other than the sulfide-based solid electrolyte, and may be, for example, an oxide-based solid electrolyte.

The coated positive electrode active material may contain particles having a large particle size due to aggregation. However, in order to improve battery characteristics of the solid-state battery 1, it is desirable that a positive electrode slurry generated in a production process of the positive electrode material does not contain large particles. Therefore, it is desirable to uniformly disperse the coated positive electrode active material before producing the positive electrode slurry so that the coated positive electrode active material does not contain large particles.

Therefore, in the positive electrode material production device and the positive electrode material production method according to the present embodiment, the coated positive electrode active material is classified in advance, and particles having a large particle size are removed.

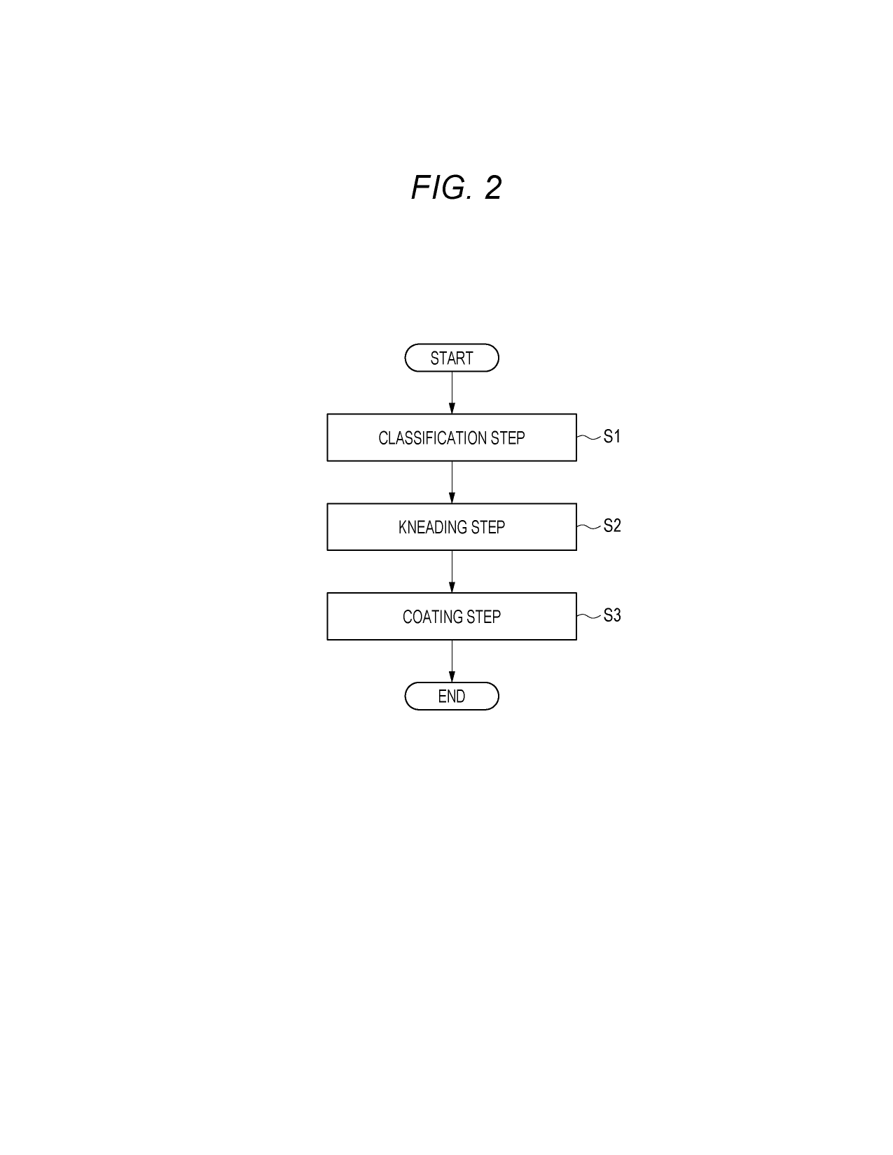

FIG. 2 is a flowchart of the positive electrode material production method. The positive electrode material production method includes a classification step S1 of classifying the coated positive electrode active material into a fine powder and a coarse powder, a kneading step S2 of kneading the fine powder, the solid electrolyte, and the dispersion medium to generate a positive electrode slurry, and a coating step S3 of coating the positive electrode current collector 21 with the positive electrode slurry.

In the classification step S1, the coated positive electrode active material is classified into the fine powder having a particle diameter equal to or smaller than a predetermined size and the coarse powder larger than the fine powder. Although details will be described later, in the present embodiment, in the classification step S1, the coated positive electrode active material is classified using a vibrator 113 that can vibrate at an ultrasonic vibration frequency.

In the classification step S1, a mass of the fine powder obtained by the classification is weighed. After a predetermined amount of fine powder is obtained in the classification step S1, the fine powder is proceeded to the kneading step S2.

In the kneading step S2, the fine powder, the solid electrolyte, and the dispersion medium are stirred and kneaded in a mixer for a predetermined time to generate a positive electrode slurry. The solid electrolyte used in the kneading step S2 may be the same as or different from the solid electrolyte used in the coating of the particles of the positive electrode active material.

In the coating step S3, the positive electrode slurry is applied to the positive electrode current collector 21. In the coating step S3, the positive electrode slurry may be applied to one surface of the positive electrode current collector 21, or the positive electrode slurry may be applied to both surfaces of the positive electrode current collector 21. After the coating step S3, the positive electrode current collector 21 coated with the positive electrode slurry is dried to produce a sheet-shaped positive electrode material. After the coating step S3, a step of rolling the positive electrode slurry may be performed.

Each of steps S1 to S3 of the positive electrode material production method is required to be performed in an environment of an inert atmosphere having an extremely low dew point and low oxygen. The dew point substantially indicates a degree of drying of a space, and a lower dew point indicates a higher degree of drying of a space. This is because when a material constituting the positive electrode material reacts with moisture, oxygen, nitrogen, and the like in the atmosphere and crystals containing lithium on a surface of the material, an insulating film is formed on a particle surface, and ion conductivity of the positive electrode material decreases.

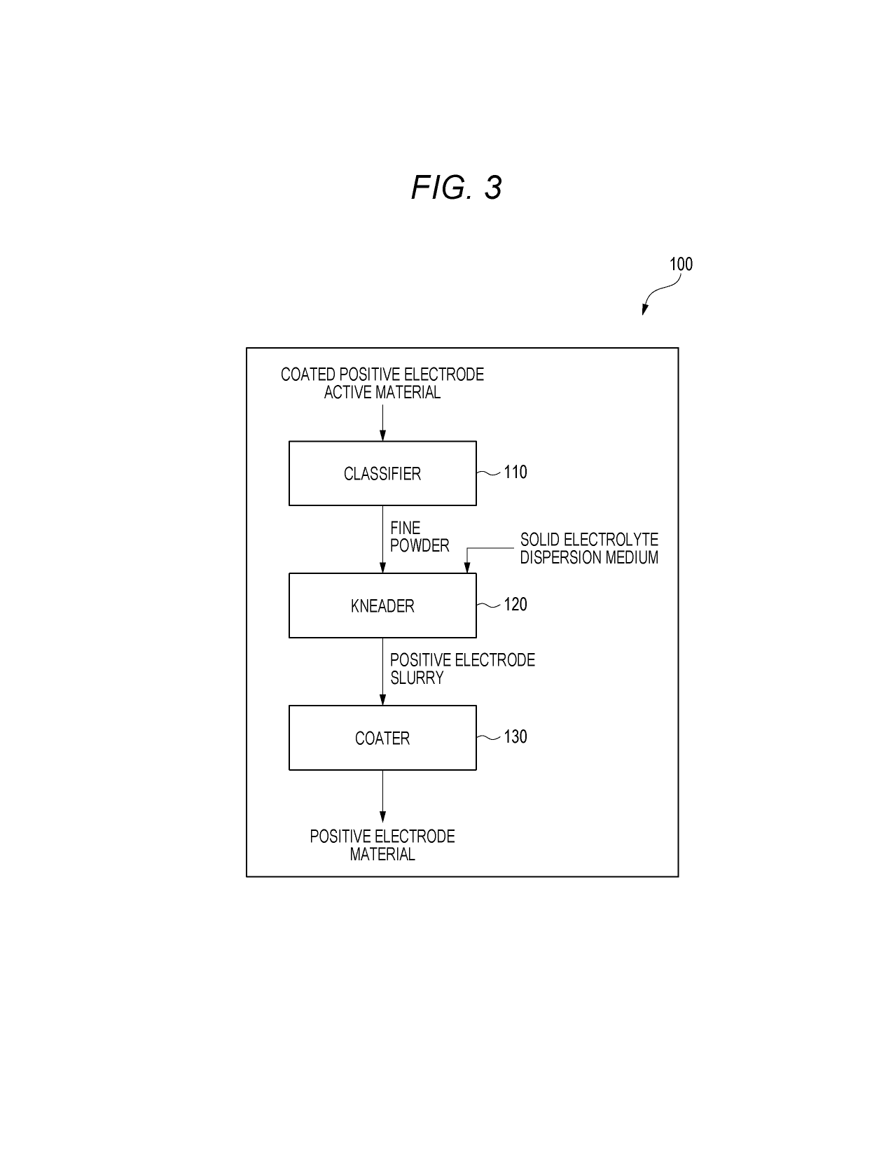

FIG. 3 is a block diagram illustrating a schematic configuration of a positive electrode material production device 100 that performs the positive electrode material production method described above. The positive electrode material production device 100 includes a classifier 110 that classifies the coated positive electrode active material into a fine powder and a coarse powder, a kneader 120 that kneads the fine powder, the solid electrolyte, and the dispersion medium to generate a positive electrode slurry, and a coater 130 that coats the positive electrode current collector 21 with the positive electrode slurry. Known devices can be applied to the kneader 120 and the coater 130, and details thereof will be omitted. The positive electrode material production device 100 is installed in an environment having an extremely low dew point and low oxygen.

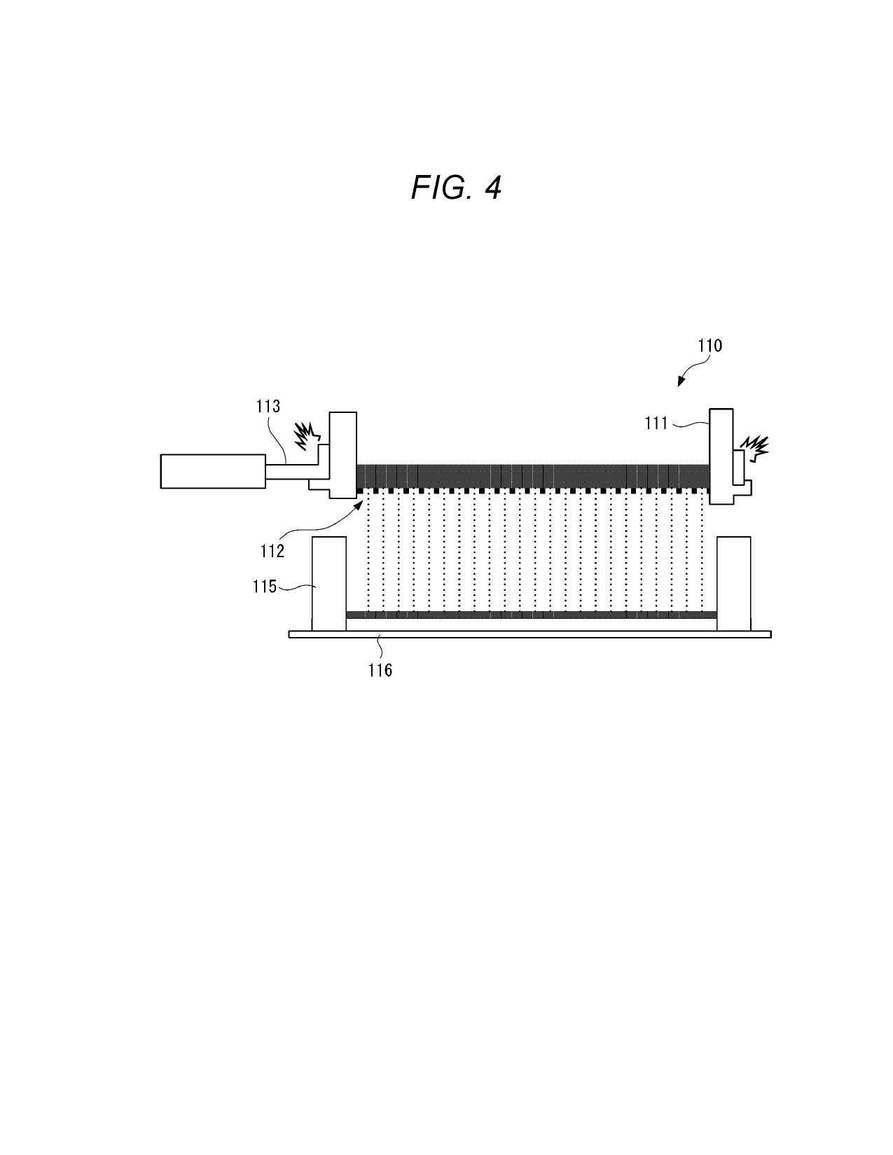

FIG. 4 is a diagram illustrating a configuration of the classifier 110. The classifier 110 includes a first container 111 in which a plurality of openings 112 are formed on a bottom surface thereof and into which a coated positive electrode active material is fed, the vibrator 113 attached to the first container 111 and capable of vibrating at an ultrasonic vibration frequency, and a second container 115 that receives a fine powder classified through the plurality of openings 112 of the first container 111. The classifier 110 is constituted by an ultrasonic shaker that classifies the coated positive electrode active material by using ultrasonic vibration frequencies. Specifically, the ultrasonic vibration frequency is a vibration frequency of 20 kHz or more.

The classifier 110 is a device that performs the classification step S1 described above. In other words, in the classification step S1, the coated positive electrode active material is classified by vibrating the first container 111, in which the plurality of openings 112 that allow the fine powder to pass through are formed on the bottom surface thereof and the coated positive electrode active material is fed, with the vibrator 113 that can vibrate at an ultrasonic vibration frequency.

The first container 111 is, for example, a bottomed container. The plurality of openings 112 formed in the bottom surface of first container 111 are formed, for example, in a mesh shape or a punched shape, but the shape thereof is not particularly limited. Each opening 112 has a size through which the fine powder can pass and a size through which a coarse powder cannot pass.

The vibrator 113 is attached to an outer peripheral surface of the first container 111 and vibrates the first container 111. The vibrator 113 is configured to vibrate at an ultrasonic vibration frequency. The vibrator 113 is configured to vibrate at a lower vibration frequency than that of ultrasonic waves. In other words, the vibrator 113 is configured to vibrate at 20 kHz or more, and is configured to vibrate even at frequencies less than 20 kHz.

The second container 115 is provided below the first container 111 and receives the fine powder classified through the plurality of openings 112 of the first container 111. The fine powder received by the second container 115 is fed into the kneader 120. Meanwhile, a powder remaining in the first container 111 without passing through the plurality of openings 112 is a coarse powder.

As described above, the coated positive electrode active material may contain particles having a large particle size due to aggregation, but since the coarse powder is removed from the coated positive electrode active material by the classifier 110 before the coated positive electrode active material is fed into the kneader 120, it is possible to prevent mixing of the coarse powder into the kneader 120. Therefore, particles having a large size that adversely affect performance of the solid-state battery 1 can be removed early in a production line of the positive electrode material production device 100.

According to the classifier 110 including the ultrasonic shaker, it is possible to shorten a time for the classification step S1 and prevent clogging as compared with a case where classification is performed by a general sieve shaker that gives amplitude to the entire device. A reason for this is presumed to be that, as compared with the sieve shaker, during an operation of the classifier 110, a movement region of the particles on the first container 111 provided with the opening 112 is narrowed, and contact between the particles is reduced, so that the particles easily pass through the opening 112 by their own weight. By shortening the time for the classification step S1 and preventing clogging, a production time of the positive electrode material can be shortened as a result.

When classifying the coated positive electrode active material, the classifier 110 preferably vibrates the vibrator 113 at 10 kHz or more. By vibrating the vibrator 113 at a vibration frequency in this range, the time for the classification step S1 can be shortened.

When classifying the coated positive electrode active material, the classifier 110 more preferably vibrates the vibrator 113 at 10 kHz or more and 35 kHz or less. By vibrating the vibrator 113 at the vibration frequency in this range, a time for the classification step S1 can be shortened. When the vibrator 113 is vibrated at a vibration frequency in this range, the contact between the particles is relatively small, and thus it is possible to prevent occurrence of defects such as peeling of the coating from the coated positive electrode active material.

A size of each opening 112 of the first container 111 is preferably designed based on a thickness of the positive electrode active material layer 22 of the solid-state battery 1 to be finally produced. Specifically, the size of each opening 112 is preferably designed to be half or less of the thickness of the positive electrode active material layer 22. For example, when the solid-state battery 1 in which the thickness of the positive electrode active material layer 22 is 100 μm is finally produced, by setting the size of each opening 112 to 50 μm, the classifier 110 can classify the coated positive electrode active material into a fine particle having a particle size of 50 μm or less and a coarse powder having a particle size of more than 50 μm. In this way, a size of each particle constituting the fine powder can be made sufficiently smaller than the thickness of the positive electrode active material layer 22.

The size of each opening 112 may be designed to be half or more of the thickness of the positive electrode active material layer 22 as long as the size is less than the thickness of the positive electrode active material layer 22. For example, when the solid-state battery 1 in which the thickness of the positive electrode active material layer 22 is 100 μm is finally produced, by setting the size of each opening 112 to 70 μm, the classifier 110 can classify the coated positive electrode active material into a fine particle having a particle size of 70 μm or less and a coarse powder having a particle size of more than 70 μm. Even with such a configuration, a size of each particle constituting the fine powder can be made smaller than the thickness of the positive electrode active material layer 22.

A processing speed of the classifier 110 changes depending on the size of the opening 112, and the processing speed increases as the opening 112 increases and the processing speed decreases as the opening 112 decreases. Here, the processing speed is, for example, an amount of the coated positive electrode active material classified per unit time. In view of this point, the size of each opening 112 is more preferably designed based on a desired processing speed in addition to the thickness of the positive electrode active material layer 22.

The processing speed of the classifier 110 is preferably set based on, for example, a time required for the coating step of coating the particles of the positive electrode active material with the particles of the solid electrolyte. For example, the processing speed is preferably set such that the classification step S1 by the classifier 110 is ended between a time point when the coated positive electrode active material generated in a certain coating step is completely fed into the classifier 110 and a time point when the coated positive electrode active material generated in the next coating step is started to be fed into the classifier 110. As an example, the processing speed is preferably set to 1.0 kg/h or more.

The classifier 110 preferably further includes a weighing portion 116 for weighing a mass of the fine powder. In other words, in the classification step S1, the mass of the fine powder obtained by the classification is preferably weighed. More specifically, the weighing portion 116 is provided in the second container 115 and weighs the mass of the fine powder received by the second container 115.

Since the weighing portion 116 is provided, an appropriate amount of fine powder can be fed into the kneader 120. Since the classifier 110 has the weighing portion 116, classification and weighing can be performed at the same time, and production efficiency of the positive electrode material can be improved.

The classifier 110 is preferably provided directly before the kneader 120 in the production line of the positive electrode material production device 100. In other words, the classification step S1 is preferably performed directly before the kneading step S2. With such a configuration, it is possible to prevent mixing of the coarse powder having large particles before kneading.

The first container 111 of the classifier 110 preferably has a size that allows 1 kg or more of the coated positive electrode active material to be fed into the first container 111. In other words, in the classification step S1, 1 kg or more of the coated positive electrode active material is preferably classified in one step. More specifically, it is preferable that the first container 111 has a size that allows 1 kg or more and 50 kg or less of the coated positive electrode active material to be fed into the first container 111. Further, it is more preferable that the first container 111 has a size that allows 15 kg or more and 50 kg or less of the coated positive electrode active material to be fed into the first container 111.

Thus, the first container 111 can receive a large amount of coated positive electrode active material, and a large amount of coated positive electrode active material can be classified at one time, so that a large amount of positive electrode material can be efficiently produced in a short time.

Although the embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

In the present specification, at least the following matters are described. In the parentheses, the corresponding constituent elements and the like in the above embodiment are shown as an example, and the present invention is not limited thereto.

(1) A positive electrode material production device (positive electrode material production device 100) for a solid-state battery (solid-state battery 1), including:

a classifier (classifier 110) configured to classify a mixed powder of a powder of a positive electrode active material and a powder of a solid electrolyte into a coarse powder and a fine powder; and

a kneader (kneader 120) configured to knead the fine powder and a dispersion medium to generate a positive electrode slurry, in which

the classifier includes:

a container (first container 111) in which the mixed powder is fed into the container, and a plurality of openings (openings 112) configured to allow the fine powder to pass through are formed in a bottom surface of the container; and

a vibrator (vibrator 113) attached to the container and configured to vibrate at an ultrasonic vibration frequency.

The mixed powder of the powder of the positive electrode active material and the powder of the solid electrolyte may contain particles having a large particle size due to aggregation. According to (1), since the mixed powder is classified into the coarse powder and the fine powder by the classifier before the mixed powder is fed into the kneader, only the fine powder excluding the coarse powder can be fed into the kneader, and mixing of the coarse powder into the positive electrode slurry can be prevented. Therefore, particles having a large size that adversely affect performance of the solid-state battery can be removed early in a production line.

Further, a time for classification can be shortened by classifying the mixed powder by the vibrator that can vibrate at an ultrasonic vibration frequency.

(2) The positive electrode material production device for the solid-state battery according to (1), in which

the classifier vibrates the vibrator at 10 kHz or more and 35 kHz or less when classifying the mixed powder.

According to (2), a time for the classification can be shortened. With the vibration frequency described in (2), it is possible to prevent the coating from peeling off from the coated positive electrode active material (positive electrode active material coated with the solid electrolyte) contained in the mixed powder.

(3) The positive electrode material production device for the solid-state battery according to (1) or (2), in which

the solid-state battery to be finally produced has a positive electrode active material layer (positive electrode active material layer 22) formed from the positive electrode slurry, and

a size of each of the openings of the classifier is half or less of a thickness of the positive electrode active material layer.

According to (3), since the size of each of the openings of the classifier is designed in consideration of the thickness of the positive electrode active material layer of the solid-state battery to be finally produced, it is possible to reliably prevent mixing of the coarse powder into the solid-state battery.

(4) The positive electrode material production device for the solid-state battery according to any one of (1) to (3), in which

the classifier further includes a weighing portion (weighing portion 116) configured to weigh a mass of the fine powder.

According to (4), since the classification and the weighing can be performed at the same time, production efficiency of the positive electrode material can be improved.

(5) The positive electrode material production device for the solid-state battery according to any one of (1) to (4), in which

the classifier is provided directly before the kneader in a production line of the positive electrode material production device.

According to (5), since the classifier is provided directly before the kneader, it is possible to prevent mixing of the coarse powder before kneading.

(6) The positive electrode material production device for the solid-state battery according to any one of (1) to (5), in which

the container has a size that allows 1 kg or more of the mixed powder to be fed into the container.

According to (6), since a large amount of mixed powder is classified at one time, a large amount of positive electrode material can be produced efficiently in a short time.

(7) A positive electrode material production method for a solid-state battery (solid-state battery 1), including:

a classification step (classification step S1) of classifying a mixed powder of a powder of a positive electrode active material and a powder of a solid electrolyte into a coarse powder and a fine powder; and

a kneading step (kneading step S2) of kneading the fine powder and a dispersion medium to generate a positive electrode slurry, in which

in the classification step, the mixed powder is classified by vibrating a container (first container 111) with a vibrator (vibrator 113) configured to vibrate at an ultrasonic vibration frequency, in which a plurality of openings (openings 112) configured to allow the fine powder to pass through are formed in a bottom surface of the container, and the mixed powder is fed into the container.

The mixed powder of the powder of the positive electrode active material and the powder of the solid electrolyte may contain particles having a large particle size due to aggregation. According to (7), since the mixed powder is classified into the coarse powder and the fine powder in the classification step before the mixed powder is fed in the kneading step, only the fine powder excluding the coarse powder can be fed in the kneading step, and mixing of the coarse powder into the positive electrode slurry can be prevented. Further, a time for the classification step can be shortened by classifying the mixed powder by the vibrator that can vibrate at an ultrasonic vibration frequency.

(8) The positive electrode material production method for the solid-state battery according to (7), in which

in the classification step, the vibrator is vibrated at 10 kHz or more and 35 kHz or less.

According to (8), a time for the classification step can be shortened. With the vibration frequency described in (8), it is possible to prevent peeling of the coating from the coated positive electrode active material (positive electrode active material coated with the solid electrolyte) contained in the mixed powder.

(9) The positive electrode material production method for the solid-state battery according to (7) or (8), in which

the solid-state battery to be finally produced has a positive electrode active material layer formed from the positive electrode slurry, and

a size of each of the openings of the container is half or less of a thickness of the positive electrode active material layer.

According to (9), since the size of each of the openings of the container is designed in consideration of the thickness of the positive electrode active material layer of the solid-state battery to be finally produced, it is possible to reliably prevent mixing of the coarse powder into the solid-state battery.

(10.) The positive electrode material production method for the solid-state battery according to any one of (7) to (9), in which

in the classification step, a mass of the fine powder obtained by classification is weighed.

According to (10), since the classification and the weighing can be performed at the same time, production efficiency of the positive electrode material can be improved.

(11) The positive electrode material production method for the solid-state battery according to any one of (7) to (10), in which

the classification step is performed directly before the kneading step.

According to (11), since the classification step is performed directly before the kneading step, it is possible to prevent mixing of the coarse powder before kneading.

(12) The positive electrode material production method for the solid-state battery according to any one of (7) to (11), in which

in the classification step, 1 kg or more of the mixed powder is classified in one step.

According to (12), since a large amount of mixed powder is classified at one time, a large amount of positive electrode material can be produced efficiently in a short time.

What is claimed is:

1. A positive electrode material production device for a solid-state battery, comprising:
a classifier configured to classify a mixed powder of a powder of a positive electrode active material and a powder of a solid electrolyte into a coarse powder and a fine powder; and
a kneader configured to knead the fine powder and a dispersion medium to generate a positive electrode slurry, wherein
the classifier includes:
a container in which the mixed powder is fed into the container, and a plurality of openings configured to allow the fine powder to pass through are formed in a bottom surface of the container; and
a vibrator attached to the container and configured to vibrate at an ultrasonic vibration frequency.

2. The positive electrode material production device for the solid-state battery according to claim 1, wherein
the classifier vibrates the vibrator at 10 kHz or more and 35 kHz or less when classifying the mixed powder.

3. The positive electrode material production device for the solid-state battery according to claim 1, wherein
the solid-state battery to be finally produced has a positive electrode active material layer formed from the positive electrode slurry, and
a size of each of the openings of the classifier is half or less of a thickness of the positive electrode active material layer.

4. The positive electrode material production device for the solid-state battery according to claim 1, wherein
the classifier further includes a weighing portion configured to weigh a mass of the fine powder.

5. The positive electrode material production device for the solid-state battery according to claim 1, wherein
the classifier is provided directly before the kneader in a production line of the positive electrode material production device.

6. The positive electrode material production device for the solid-state battery according to claim 1, wherein
the container has a size that allows 1 kg or more of the mixed powder to be fed into the container.

7. A positive electrode material production method for a solid-state battery, comprising:
classifying a mixed powder of a powder of a positive electrode active material and a powder of a solid electrolyte into a coarse powder and a fine powder; and
kneading the fine powder and a dispersion medium to generate a positive electrode slurry, wherein
in the classifying the mixed powder, the mixed powder is classified by vibrating a container with a vibrator configured to vibrate at an ultrasonic vibration frequency, in which a plurality of openings configured to allow the fine powder to pass through are formed in a bottom surface of the container, and the mixed powder is fed into the container.

8. The positive electrode material production method for the solid-state battery according to claim 7, wherein
in the classifying the mixed powder, the vibrator is vibrated at 10 kHz or more and 35 kHz or less.

9. The positive electrode material production method for the solid-state battery according to claim 7, wherein
the solid-state battery to be finally produced has a positive electrode active material layer formed from the positive electrode slurry, and
a size of each of the openings of the container is half or less of a thickness of the positive electrode active material layer.

10. The positive electrode material production method for the solid-state battery according to claim 7, wherein
in the classifying the mixed powder, a mass of the fine powder obtained by classification is weighed.

11. The positive electrode material production method for the solid-state battery according to claim 7, wherein
the classifying the mixed powder is performed directly before the kneading the fine powder and the dispersion medium.

12. The positive electrode material production method for the solid-state battery according to claim 7, wherein
in the classifying the mixed powder, 1 kg or more of the mixed powder is classified in one step.
